(19) United States
(12) Patent Application Publication
(10) Pub. No.: US 2012/0184702 A1
(43) Pub. Date: Jul. 19, 2012

(54) PROCESS FOR PRODUCING A COMPOSITE MATERIAL

(75) Inventors: Arno Lange, Bad Durkheim (DE); Gerhard Cox, Bad Durkheim (DE); Rainer Dyllick-Brenzinger, Neustadt (DE); Oliver Gronwald, Frankfurt (DE); Theo Smit, Heidelberg (DE)

(73) Assignee: BASF SE, Ludwigshafen (DE)

(21) Appl. No.: 13/353,780

(22) Filed: Jan. 19, 2012

Related U.S. Application Data
(60) Provisional application No. 61/434,009, filed on Jan. 19, 2011.

(30) Foreign Application Priority Data
Nov. 4, 2011 (EP) 11187933.4

(51) Int. Cl. C08G 79/08; C08G 79/04; C08G 79/00; C08G 77/02

(52) U.S. Cl. 528/8; 528/26; 528/365; 528/9

(57) ABSTRACT

The present invention relates to a process for producing composite materials which consist essentially of
a) at least one oxidic phase; and
b) at least one organic polymer phase;
   by copolymerizing
   at least one compound A selected from aryloxy metalates, aryloxy semimetalates and aryloxy esters of nonmetals which form oxo acids and are different than carbon and nitrogen with
   at least one compound B selected from formaldehyde and formaldehyde equivalents,
      in a reaction medium which is essentially anhydrous, wherein the compound B is used in such an amount that the molar ratio of formaldehyde to the aryloxy groups in compound A is at least 0.9:1.

The present invention relates to a process for producing a composite material from

a) at least one oxidic phase; and
b) at least one organic polymer phase.

In recent times, there have been various descriptions of the production of composite materials by what is called twin polymerization (see, for example, Spange et al., Angew. Chem. Int. Ed., 46 (2007) 628-632, WO 2009/083083, WO 2009/133086, WO 2010/112581 and WO2010/128144). Twin polymerization involves polymerizing compounds which possess a plurality of arylmethyl groups which are bonded to a metal or semimetal atom via one or two heteroatom(s), preferably one or two oxygen atom(s).

Twin polymerization affords composite materials which typically have at least one oxidic phase and at least one organic polymer phase, in which the phase domains have a co-continuous arrangement and dimensions in the region of a few nanometers (distance between adjacent identical phases). It is assumed that the specific phase arrangement and the small distances between adjacent phases are a consequence firstly of the kinetic coupling of the polymerization of the arylmethyl units in the twin monomers, and secondly of the formation of the silicon dioxide. As a result, the phase constituents form more or less synchronously, and phase separation into the inorganic phase and the organic phase takes place as early as during the polymerization of the twin monomers.

Preferred twin monomers are spirocyclic compounds as described in WO 2009/083083. In these spirocyclic compounds, two 1-oxy-2-(oxymethyl)aryl groups are joined via their oxygen atoms to a metal or semimetal atom to form a spirocyclic structure. One example of such a spirocyclic compound is 2,2′-spiro[4H-1,3,2-benzodioxasilin].

The spirocyclic compounds can be prepared by the method described in WO 2009/083083, in a comparatively simple manner, by reacting 1-hydroxy-2-hydroxymethylaromatics such as 1-hydroxy-2-hydroxymethylbenzene (saligenin) with metal alkoxides or semimetal alkoxides. However, the preparation of the starting materials, namely of the 1-hydroxy-2-hydroxymethylaromatics, is comparatively complex. 1-Hydroxy-2-hydroxymethylaromatics are, in a formal sense, monoaddition products of formaldehyde onto hydroxyaromatics. However, in addition of formaldehyde onto hydroxyaromatics such as phenol generally does not lead to the desired monoadduct but to the o,o-bishydroxymethyl compound (see Rec. Tray. Chim. Pays-Bas 62, 57 (1943)). It is also known that o-hydroxyarylcarboxylic aids such as salicylic acid can be reduced with suitable reducing agents to the corresponding 1-hydroxy-2-hydroxymethylaromatics (see J. Chem. Soc. PT1, (1981) 1942-1952 and Bull. Chem. Soc. Jap. 56, 719-723, (1983)), or that phenyl borate can be reacted with formaldehyde to give the monoadduct and then the o-hydromethylphenyl borate formed can be hydrolyzed to saligenin (see FR 2626575). A common feature of all these processes is that they lead to good and reproducible results in the laboratory by virtue of purifying operations, but are complicated to perform overall. Incomplete conversion or by-products lead to product loss. Therefore, access to the spiro compounds described in WO 2009/083083 is complex and remains severely restricted, which has to date been a barrier to industrial use of twin polymerization for production of nanocomposite materials.

DE 1816241 discloses the preparation of soluble metal- or semimetal-containing phenol-formaldehyde resins, in which either particular metal or semimetal phenoxides are reacted with substoichiometric amounts of formaldehyde, or novolacs, i.e. phenol-formaldehyde condensates, are reacted with selected inorganic metal or semimetal compounds. The production of composite materials with a phase structure whose phase domains have dimensions in the nanometer range is not described.

It has now been found that, surprisingly, by copolymerizing
at least one compound A selected from aryloxy metalates, aryloxy semimetalates and aryloxy esters of nonmetals which form oxo acids and are different than carbon and nitrogen with
at least one compound B selected from formaldehyde and formaldehyde equivalents,
   in a reaction medium which is essentially anhydrous, wherein the compound B is used in such an amount that the molar ratio of formaldehyde to the aryloxy groups in compound A is at least 0.9:1, it is possible to produce composite materials which have an arrangement of phase domains similar to those nanocomposite materials which are obtainable by twin polymerization as described in the prior art.

This is surprising since it has been assumed to date that the formation of nanocomposite materials is attributable to the structural units present in twin monomers, which have arylmethylene groups bonded covalently to a metal or semimetal via a heteroatom. It has been assumed to date that these structural units bring about kinetic coupling of the polymerization of the organic molecular moiety of the twin monomers and of the formation of the “inorganic polymer”, namely the inorganic phase, since polymerization and formation of the inorganic phase have a common reaction step, namely the breaking of the bond between the methylene carbon of the arylmethylene group and the heteroatom bearing the (semi)metal. The resulting kinetic coupling was considered to be the cause of the formation of the characteristic nanostructures in the twin polymerization. However, the characteristic structural units of the twin monomers do not have aryloxy metalates, aryloxy semimetalates and aryloxy esters of nonmetals.

The present invention thus relates to a process of producing composite materials which consist essentially of

a) at least one oxidic phase; and
b) at least one organic polymer phase;
said process comprising the Copolymerization of
at least one compound A selected from aryloxy metalates, aryloxy semimetalates and aryloxy esters of nonmetals which form oxo acids and are different than carbon and nitrogen with
at least one compound B selected from formaldehyde and formaldehyde equivalents,
   in a reaction medium which is essentially anhydrous, wherein the compound B is used in such an amount that the molar ratio of formaldehyde or formaldehyde equivalents in compound B to the aryloxy groups in compound A is at least 0.9:1, especially at least 1:1, particularly at least 1.01:1 and specifically at least 1.05:1.

The process according to the invention is a associated with a number of advantages. Firstly, the process according to the invention affords composite materials as also obtained in twin polymerization, i.e. composite materials which consist of

a) at least one oxidic phase; and
b) at least one organic polymer phase,
said oxidic phase and said organic polymer phase consisting essentially of phase domains, in which the mean distance between adjacent phase domains of identical phases is very small. Unlike the case of twin polymerization, however, no starting materials which are difficult to obtain are needed, such as the spiro compounds mentioned at the outset or labile arylmethyl(semi)metalates such as tetrakis(furylmethyloxy)silane, in order to arrive at the desired composite materials. Instead, it is possible to use readily obtainable and comparatively stable starting materials in the form of the aryloxy metalates, aryloxy semimetalates and aryloxy esters of nonmetals, which allows production of the composite materials on a larger scale.

In addition, the process according to the invention enables, by selection of suitable compounds A or mixtures of compounds A, the controlled modification of the substance properties of the composite material obtainable thereby. For example, the properties of the inorganic polymer phase can be modified by copolymerizing mixtures of different compounds A which differ in the type of metal, semimetal or nonmetal with one another. In an analogous manner, it is possible, for example, to modify the properties of the organic polymer phase by copolymerizing mixtures of different compounds A which differ in the type of aryl group with one another. It is equally possible, for example, to modify the properties of the organic and inorganic polymer phase by copolymerizing mixtures of different compounds A which differ both in the type of metal, semimetal or nonmetal and in the aryl group with one another.

As already mentioned, the process according to the invention affords composite materials which consist of at least one oxidic phase and at least one organic polymer phase, said oxidic phase and said organic polymer phase consisting essentially of phase domains in which the mean distance between adjacent phase domains of identical phases is very small. The mean distance between adjacent phase domains of identical phases is typically less than 200 nm, frequently less than 100 nm or less than 50 nm, and especially less than 10 nm. Adjacent phase domains of identical phases are understood to mean two phase domains of two identical phases which are separated by one phase domain of the other phase, for example two phase domains of the oxide phase which are separated by one phase domain of the organic polymer phase, or two phase domains of the polymer phase which are separated by one phase domain of the oxide phase.

Aryloxy metalates, aryloxy semimetalates and aryloxy esters are understood to mean compounds which are based on monohydroxyaromatics and which, in a formal sense, have one or more, especially 1, 2, 3, 4, 5 or 6, aryloxy groups or anions derived from monohydroxyaromatics by deprotination of the aromatic hydroxyl function, the aryloxy group(s) or anion(s) derived from the monohydroxyaromatic being bonded to a metal, semimetal or nonmetal via the deprotinated oxygen atom of the hydroxyl group of the monohydroxyaromatic. The metal, semimetal or nonmetal atoms which form oxo acids and which are different than C and N are also referred to hereinafter as central atoms. The compounds A may have one or more central atoms and, in the case of more than one central atom, may have linear, branched, monocyclic or polycyclic structures.

Suitable monohydroxyaromatics are in particular phenol, α-naphthol or β-naphthol, which are unsubstituted or have one or more, for example 1, 2, 3 or 4, substituents which are typically selected from alkyl, cycloalkyl, alkoxy, cycloalkoxy and NR^{a}R^{b} in which R^{a} and R^{b} are each independently hydrogen, alkyl or cycloalkyl.

Here and hereinafter, the terms “alkyl”, “alkenyl”, “cycloalkyl”, “alkoxy”, “cycloalkoxy” and “aryl” are collective terms for monovalent organic radicals with the usual definition thereof, where alkyl and alkoxy typically have 1 to 20, frequently 1 to 10 and especially 1 to 4 carbon atoms, and cycloalkyl and cycloalkoxy typically 3 to 20, frequently 3 to 10 and especially 5 or 6 carbon atoms. The possible number of carbon atoms in a radical is typically specified by the prefix Cₙ-Cₘ where n is the minimum and m is the maximum carbon number.

In this context, alkyl is a saturated, linear or branched hydrocarbyl radical which has typically 1 to 20, frequently 1 to 10 and especially 1 to 4 carbon atoms, and which is, for example, methyl, ethyl, n-propyl, isopropyl, n-butyl, 2-butyl, isobutyl, tert-butyl, n-pentyl, 2-methylbutyl, 1-methylbutyl, 3-pentyl, n-hexyl, n-heptyl, n-octyl, 1-methylheptyl, 2-methylheptyl, 2-ethylhexyl, n-nonyl, 1-methylnonyl, n-decyl, 3-propylheptyl and the like.

Alkenyl is an olefinically unsaturated, linear or branched hydrocarbyl radical which has typically 2 to 20, frequently 2 to 10 and especially 2 to 6 carbon atoms and which is, for example, vinyl, 1-propenyl, 2-propenyl, 1-methylethenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl.

Alkoxy is an alkyl radical as defined above bonded via an oxygen atom, which has typically 1 to 20, frequently 1 to 10 and especially 1 to 4 carbon atoms, and which is, for example, methoxy, ethoxy, n-propoxy, isopropoxy, n-butoxy, 2-butoxy, isobutoxy, tert-butoxy, n-pentyloxy, 2-methylbutyloxy, 1-methylbutyloxy, n-hexyloxy, n-heptyloxy, n-octyloxy, 1-methylheptyloxy, 2-methylheptyloxy, 2-ethylhexyloxy, n-nonyloxy, 1-methylnonyloxy, n-decyloxy, 3-propylheptyloxy and the like.

Cycloalkyl is a mono-, bi- or tricyclic, saturated cycloaliphatic radical which has typically 3 to 20, frequently 3 to 10 and especially 5 or 6 carbon atoms, and which is, for example, cyclopropyl, cyclobutyl, cyclopentyl, cyclopentyl, cyclohexyl, cycloheptyl, cyclooctyl, bicyclo[2.2.1]hept-1-yl, bicyclo[2.2.1]hept-2-yl, bicyclo[2.2.1]hept-7-yl, bicyclo[2.2.2]octan-1-yl, bicyclo[2.2.2]octan-2-yl, 1-adamantyl or 2-adamantyl.

Cycloalkyloxy is a mono-, bi- or tricyclic, saturated cycloaliphatic radical bonded via an oxygen atom, which has typically 3 to 20, frequently 3 to 10 and especially 5 or 6 carbon atoms, and which is, for example, cyclopropyloxy, cyclobutyloxy, cyclopentyloxy, cyclopentyloxy, cyclohexyloxy, cycloheptyloxy, cyclooctyloxy, bicyclo[2.2.1]hept-1-yloxy, bicyclo[2.2.1]hept-2-yloxy, bicyclo[2.2.1]hept-7-yloxy, bicyclo[2.2.2]octan-1-yloxy, bicyclo[2.2.2]octan-2-yloxy, 1-adamantyloxy or 2-adamantyloxy.

Aryl is a mono- or polycyclic aromatic hydrocarbyl radical, for example phenyl, 1-naphthyl or 2-naphthyl.

In addition to the aryloxy radical(s), further groups may be bonded to the central atom(s), for example 1, 2 or 3 organic radicals which are selected, for example, from alkyl, alkenyl, cycloalkyl or aryl, or 1 or 2 oxygen atoms. The total number of bonded groups is typically determined by the valency of the central atom, i.e. of the metal, semimetal or nonmetal to which these groups are bonded.

Typically, the central atoms of the compounds A are selected from the elements other than carbon and nitrogen from the following groups of the Periodic Table: IA such as Li, Na or K, IIA such as Mg, Ca, Sr or Ba, IIIA such as B, Al, Ga or In, IVA such as Si, Ge, Sn or Pb, VA such as P, As or Sb, VIA such as S, Se or Te, IVB such as Ti or Zr, VB such as V, VIB such as Cr, Mo or W and VIIB such as Mn. The central atoms of the compounds A are preferably selected from the elements other than carbon and nitrogen from groups IIIA, IVA, VA and IVB of the Periodic Table, and among these especially from the elements of the 2nd, 3rd and 4th period. The central atoms are more preferably selected from B, Al, Si, Sn, Ti and P.

In a specific embodiment of the invention, the compounds used are aryloxy semimetalates, i.e. compounds of semimetals such as B or Si. In a specific embodiment of the invention, the compound A is selected from aryloxy semimetalates in which the semimetal comprises at least 90 mol %, based on the total amount of semimetal atoms, of silicon.

Compounds A suitable in accordance with the invention can be described in particular by the following general formula I:

[(ArO)ₘMOₙRₚ]_{q} (I)

in which
M is a metal, semimetal or a nonmetal which forms oxo acids and is different than carbon and nitrogen;
m is 1, 2, 3, 4, 5 or 6,
n is 0, 1 or 2,
p is 0, 1 or 2,
q is 1 or an integer >1, for example an integer from 2 to 20, especially an integer from 3 to 6,
m+2n+p is 1, 2, 3, 4, 5 or 6 and corresponds to the valency of M,
Ar is phenyl or naphthyl, where the phenyl ring or the naphthyl ring is unsubstituted or may have one or more, for example 1, 2 or 3, substituents selected from alkyl, cycloalkyl, alkoxy, cycloalkoxy and NR^{a}R^{b} in which R^{a} and R^{b} are each independently hydrogen, alkyl or cycloalkyl;
R is alkyl, alkenyl, cycloalkyl or aryl, where aryl is unsubstituted or may have one or more, for example 1, 2 or 3, substituents selected from alkyl, cycloalkyl, alkoxy, cycloalkoxy and NR^{a}R^{b} in which R^{a} and R^{b} are each as defined above.

When m in the formula I is 2, 3, 4, 5 or 6, the Ar radicals may of course be the same or different, where different Ar may differ in the type of aromatic cycle and/or in the type of substitution pattern. When p in the formula I is 2, the R radicals may of course be the same or different.

Formula I should be understood as an empirical formula; it indicates the type and number of the structural units characteristic of the compounds A, namely the central atom M and the groups bonded to the central atom, i.e. the aryloxy group ArO, oxygen atoms O and the carbon-bonded R radicals, and the number of these units. The [(ArO)ₘMOₙRₚ] units may, when q>1, form mono- or polycyclic structures or linear structures.

In formula I, M is a metal or semimetal or a nonmetal which forms oxo acids and is different than carbon and nitrogen, the metals, semimetals and nonmetals generally being selected from the elements of the following groups of the Periodic Table other than nitrogen and carbon: IA such as Li, Na or K, IIA such as Mg, Ca, Sr or Ba, IIIA such as B, Al, Ga or In, IVA such as Si, Ge, Sn or Pb, VA such as P, As or Sb, VIA such as S, Se or Te, IVB such as Ti or Zr, VB such as V, VIB such as Cr, Mo or W and VIIB such as Mn. M is preferably selected from the elements other than carbon and nitrogen from groups IIIA, IVA, VA and IVB of the Periodic Table, and among these especially from the elements of the 2nd, 3rd and 4th period. M is more preferably selected from B, Al, Si, Sn, Ti and P. In a particularly preferred embodiment of the invention, M is B or Si and is especially Si.

In a preferred embodiment of the invention, p in formula I is 0, which means that the atom M does not bear any R radicals. In another preferred embodiment of the invention, at least two different compounds A are copolymerized with formaldehyde or a formaldehyde equivalent, where the variable p=0 in at least one of the compounds of the formula I and variable p=0 in at least one further compound of the formula I.

Irrespective of this, the variables m, n, p, Ar and R in formula I, alone or in combination, and especially in combination with one of the preferred and particularly preferred definitions of M, are preferably each defined as follows:
m is 2, 3 or 4;
n is 0 or 1;
p is 0, 1 or 2, especially 0;
Ar is phenyl which is unsubstituted or may have 1, 2 or 3 substituents selected from alkyl, especially C₁-C₄-alkyl, cycloalkyl, especially C₃-C₁₀-cycloalkyl, alkoxy, especially C₁-C₄-alkoxy, cycloalkoxy, especially C₃-C₁₀-cycloalkoxy and NR^{a}R^{b} in which R^{a} and R^{b} are each independently hydrogen, alkyl, especially C₁-C₄-alkyl, or cycloalkyl, especially C₃-C₁₀-cycloalkyl;
R if present is C₁-C₆-alkyl, C₂-C₆-alkenyl, C₃-C₁₀-cycloalkyl or phenyl, especially C₁-C₄-alkyl, C₅-C₆-cycloalkyl or phenyl.

More particularly, the variables m, n, p, Ar and R in formula I, alone or in combination, and especially in combination with one of the preferred and particularly preferred definitions of M, are preferably each defined as follows:
m is 1, 2, 3 or 4;
n is 0 or 1;
p is 0;
Ar is phenyl which is unsubstituted or may have 1, 2 or 3 substituents selected from alkyl, especially C₁-C₄-alkyl, and alkoxy, especially C₁-C₄-alkoxy.

A preferred embodiment of the compounds A is those compounds of the formula I in which q is 1. Such compounds can be viewed as orthoesters of the parent oxo acid of the central atom M. In these compounds, the variables m, n, p, M, Ar and R are each as defined above and especially have, alone or in combination, and specifically in combination, one of the preferred or particularly preferred definitions.

A particularly preferred embodiment of the compounds A is those compounds of the formula I in which M is selected from B, Si, Sn, Ti and P, m is 3 or 4, n is 0 or 1, p is 0 and q=1. Ar therein has the aforementioned definitions and especially those mentioned as preferred, and is especially phenyl which is unsubstituted or may have 1, 2 or 3 substituents selected from alkyl, especially C₁-C₄-alkyl, and alkoxy, especially C₁-C₄-alkoxy.

A very particularly preferred embodiment of the compounds A is those compounds of the formula I in which M is selected from B, Si and Sn, m is 3 or 4, n is 0 and p is 0 and q=1. Ar therein has the aforementioned definitions and especially those mentioned as preferred, and is especially phenyl which is unsubstituted or may have 1, 2 or 3 substituents selected from alkyl, especially C₁-C₄-alkyl, and alkoxy, especially C₁-C₄-alkoxy.

A specific embodiment of the compounds A is those compounds of the formula I in which M is Si, m is 4, n is 0 and p is 0. Ar therein has the aforementioned definitions and especially those mentioned as preferred, and is especially phenyl which is unsubstituted or may have 1, 2 or 3 substituents selected from alkyl, especially C₁-C₄-alkyl, and alkoxy, especially C₁-C₄-alkoxy.

Examples of compounds of the formula I where q=1 which are preferred in accordance with the invention are tetraphenoxysilane, tetra(4-methylphenoxy)silane, triphenyl borate, triphenyl phosphate, tetraphenyl titanate, tetracresyl titanate and tetraphenyl stannate.

Further embodiments of compounds A are those compounds of the general formula I in which the Ar radicals are different than one another. As a result, the melting point of the compounds A is generally lowered, which can give advantages in the polymerization.

Examples of compounds of the formula I which have different Ar and are preferred in accordance with the invention are triphenoxy(4-methylphenoxy)silane, diphenoxybis-(4-methylphenoxy)silane, diphenyl(4-methylphenyl)borate, triphenyl(4-methylphenyl)-titanate and diphenylbis(4-methylphenyl)titanate and mixtures thereof.

A further specific embodiment of the compounds A is those compounds of the formula I in which M is Si, m is 1, 2 or 3, n is 0 and p is 4-m. Ar therein has the aforementioned definitions and especially with the definitions mentioned as preferred, and especially phenyl which is unsubstituted or may have 1, 2 or 3 substituents selected from alkyl, especially C₁-C₄-alkyl, and alkoxy, especially C₁-C₄-alkoxy. In these compounds, R is as defined for formula I; more particularly, R is methyl, ethyl, phenyl, vinyl or allyl. Examples of preferred compounds A of this embodiment are methyl(triphenoxy)silane, di methyl(diphenoxy)silane, trimethyl(phenoxy)silane, phenyl(triphenoxy)silane and diphenyl(diphenoxy)silane.

Also suitable as compounds A are “condensation products” of compounds of the formula I where q=1. These compounds generally have the empirical formula I in which q is an integer >1, for example an integer in the range from 2 to 20 and especially 3, 4, 5 or 6. Such compounds derive in a formal sense by condensation of compounds of the formula I where q=1, with formal removal in each case of 2 ArO units to form an Ar—O—Ar molecule and an M(OAr)ₘ₋₂(O)ₙ₊₁Rₚ unit. They are accordingly formed essentially from the structural elements of the following formula Ia:

-[—O-A-]- (Ia)

in which -A- is a >M(ArO)ₘ₋₂(O)ₙ(R)ₚ group in which M, Ar and R each have the aforementioned definitions, especially those mentioned as preferred or particularly preferred,
m is 3 or 4,
n is 0 or 1 and especially 0,
p is 0 or 1 and especially 0,
m+2n+p is 3, 4, 5 or 6 and corresponds to the valency of M.
   M in the formula A is preferably Si, Sn, B and P.

In a preferred embodiment, the condensation product is cyclic and q is 3, 4 or 5. Such compounds can especially be described by the following structure:

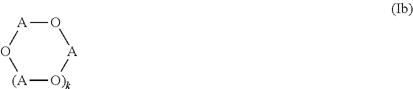

in which k is 1, 2 or 3 and -A- is a >M(ArO)ₘ₋₂(O)ₙ(R)ₚ group in which M, Ar and R have the definitions mentioned above for formula I, and m, n and p have the definitions mentioned above in connection with structure Ia.

In a further preferred embodiment, the condensation product is linear and is saturated at the ends with an ArO unit. In other words, such compounds can be described by the following structure Ic:

Ar—[—O-A-]_{q}-OAr (Ic)

in which q is an integer in the range from 2 to 20 and -A- is a >M(ArO)ₘ₋₂(O)ₙ(R)ₚ group in which M, Ar and R have the definitions mentioned above for formula I, and m, n and p have the definitions mentioned above in connection with structure Ia. Particular preference is given to this embodiment when compounds have a distribution with regard to the number of repeat units, i.e. are present with different q. For example, it is possible for mixtures to be present in which at least 99%, 90%, 80% or 60% of the mass is present as an oligomer mixture where q=2 to 6 or q=4 to 9 or q=6 to 15 or q=12 to 20.

Examples of such condensation products are triphenyl metaborate, hexaphenoxycyclotrisiloxane or octaphenoxycyclotetrasiloxane.

The compounds A are known or can be prepared in analogy to known methods for preparation of phenoxides; see, for example, O.F.Senn, WADC Technical Report 54-339, SRI (1955), DE 1816241, Z. Anorg. Allg. Chem. 551, 61-66 (1987), Houben-Weyl, volume VI-2 35-41, Z. Chem. 5, 122-130 (1965).

In a further embodiment of the invention, the compounds A comprise at least two different compounds A1 and A2, compound Al being selected from compounds of the formula I in which M is B, Si, Sn, Ti or P and is especially B, Si or Sn, m is 1, 2, 3 or 4, n is 0 or 1, especially 0, p is 0 and q is 0, 1, 3 or 4, and compound A2 being selected from compounds of the formula I in which M is selected from Si and Sn, m is 2, n is 0, q=0 and p is 2. Ar in the compounds A1 and A2 may be the same or different, where Ar has the aforementioned definitions and especially those mentioned as preferred, and is especially phenyl which is unsubstituted or may have 1, 2 or 3 substituents selected from alkyl, especially C₁-C₄-alkyl, and alkoxy, especially C₁-C₄-alkoxy. R is then preferably C₁-C₆-alkyl, C₃-C₁₀-cycloalkyl or phenyl, especially C₁-C₄-alkyl, C₅-C₆-cycloalkyl or phenyl.

In a further, specific embodiment of the invention, the compounds A comprise at least two different compounds A1 and A2, compound Al being selected from compounds of the formula I in which M is Si, m is 2 or 4, n is 0, p is 0 and q is 1, 3 or 4, and compound A2 being selected from compounds of the formula I in which M is Si, m is 2, n is 0 and p is 2. Ar in the compounds A1 and A2 may be the same or different, where Ar has the aforementioned definitions and especially those mentioned as preferred, and is especially phenyl which is unsubstituted or may have 1, 2 or 3 substituents selected from alkyl, especially C₁-C₄-alkyl, and alkoxy, especially C₁-C₄-alkoxy. R is then preferably C₁-C₆-alkyl, C₃-C₁₀-cycloalkyl or phenyl, especially C₁-C₄-alkyl, C₅-C₆-cycloalkyl or phenyl.

In the process according to the invention, the compounds A and formaldehyde or the formaldehyde equivalent (compounds B) are used in such an amount that the molar ratio of formaldehyde in compound B, i.e. the amount of monomeric formaldehyde used, or the amount of formaldehyde present in the formaldehyde equivalent when a formaldehyde equivalent is used, to the aryloxy groups ArO present in the compounds A is at least 0.9:1, preferably at least 1:1, particularly at least 1.01:1, more preferably at least 1.05:1 and especially at least 1.1:1. Greater excesses of formaldehyde are generally uncritical but unnecessary, and so formaldehyde or the formaldehyde equivalent is typically used in such an amount that the molar ratio of formaldehyde, or the molar ratio of the formaldehyde present in the formaldehyde equivalent, to the aryloxy groups ArO present in the compounds A does not exceed a value of 10:1, preferably 5:1 and especially 2:1. Preference is given to using formaldehyde or the formaldehyde equivalent in such an amount that the molar ratio of formaldehyde, or the molar ratio of the formaldehyde present in the formaldehyde equivalent, to the aryloxy groups ArO present in the compounds A is in the range from 1:1 to 10:1, particularly in the range from 1.01:1 to 5:1 and especially in the range from 1.05:1 to 5:1 or 1.1:1 to 2:1.

A formaldehyde equivalent is understood to mean a compound which releases formaldehyde under polymerization conditions. The formaldehyde equivalent is preferably an oligomer or polymer of formaldehyde, i.e. a substance with the empirical formula (CH₂O)ₓ where x specifies the degree of polymerization. These include in particular trioxane (3 formaldehyde units) and paraformaldehyde (higher oligomer (CH₂O)ₓ).

Preference is given to effecting the polymerization using compounds B (hereinafter, also formaldehyde source) selected from gaseous formaldehyde, trioxane and paraformaldehyde. The compound is especially trioxane.

In a preferred embodiment of the process according to the invention, the polymerization of the compounds A with the formaldehyde source is effected in the presence of catalytic amounts of an acid. Typically, the acid is used in an amount of 0.1 to 10% by weight, especially 0.2 to 5% by weight, based on the compounds A. Preferred acids here are Brønsted acids, for example carboxylic acids, for example trifluoroacetic acid, oxalic acid or lactic acid, and also organic sulfonic acids, especially C₁-C₂₀-alkanesulfonic acids, such as methanesulfonic acid, octanesulfonic acid, decanesulfonic acid or dodecanesulfonic acid, haloalkanesulfonic acids such as trifluoromethanesulfonic acid, benzenesulfonic acid or C₁-C₂₀-alkylbenzenesulfonic acids, toluenesulfonic acid, nonylbenzenesulfonic acid or dodecylbenzenesulfonic acid. Likewise suitable are inorganic Brønsted acids such as HCl, H₂SO₄ or HClO₄. The Lewis acid used may, for example, be BF₃, BCl₃, SnCl₄, TiCl₄ or AlCl₃. It is also possible to use Lewis acids in complex-bound form or dissolved in ionic liquids.

The polymerization can also be catalyzed with bases. Examples are amines such as triethylamine or dimethylaniline, hydroxides and basic salts of alkali metals and alkaline earth metals such as LiOH, NaOH, KOH, Ca(OH)₂, Ba(OH)₂ or Na₃PO₄, and also alkoxides of alkali metals and alkaline earth metals, such as sodium methoxide, sodium ethoxide, potassium t-butoxide or magnesium ethoxide.

The polymerization can also be initiated thermally, i.e. the polymerization is effected without the addition of an acid, by heating a mixture of compounds A and B.

The temperatures required for the polymerization are typically within the range from 50 to 250° C., especially within the range from 80 to 200° C. In an acid- or base-catalyzed polymerization, the polymerization temperatures are typically in the range from 50 to 200° C. and especially in the range from 80 to 150° C. In the thermally initiated polymerization, the polymerization temperatures are typically in the range from 120 to 250° C. and especially in the range from 150 to 200° C.

The polymerization can in principle be performed as what is called a batch or addition process. In the case of performance as a batch, compounds A and B are initially charged in the desired amount in the reaction vessel and brought to the conditions required for polymerization. In the addition process, at least one of the two components, i.e. compound A and/or compound B, is supplied at least partly in the course of the polymerization until the desired ratio of compound A to compound B has been attained. The addition is optionally followed by a continued reaction phase. Preference is given to performance as a batch.

It has been found to be advantageous when the polymerization is performed in one stage, which means that the polymerization is conducted as a batch with the total amount of the compounds A and B to be polymerized, or an addition process is employed, in which compounds A and B are added in such a way that the polymerization conditions are not interrupted until the entire amount of compounds A and B has been added in the reaction vessel.

The polymerization of compounds A and B can be performed in bulk or in an inert diluent. Suitable diluents are, for example, halogenated hydrocarbons such as dichloromethane, trichloromethane, dichloroethene, or hydrocarbons, for example aromatic hydrocarbons such as mono- or poly-C₁-C-₄-alkyl-substituted benzene or naphthalene, for example toluene, xylene, cumene or mesitylene, or mono- and C₁-C-₄-alkylnaphthalenes, and also aliphatic and cycloaliphatic hydrocarbons such as hexane, cyclohexane, heptane, cycloheptane, octane and isomers thereof, nonane and isomers thereof, decane and isomers thereof, and mixtures thereof.

Preference is given to performing the polymerization of compounds A and B in the substantial absence of water, which means that the concentration of water at the start of the polymerization is less than 0.1% by weight.

For production of particulate composite materials, it has been found to be useful to conduct the reaction of compound A with compound B in an inert diluent. Preferred inert diluents are those which consist of the aforementioned hydrocarbons to an extent of at least 80% by volume, particularly to an extent of at least 90% by volume and especially to an extent of at least 99% by volume or 100% by volume, based on the total amount of diluent, aromatic hydrocarbons such as mono- or poly-C₁-C₄-alkyl-substituted benzene or naphthalene, for example toluene, xylene, cumene or mesitylene, or mono- and C₁-C₄-alkylnaphthalenes, and also aliphatic and cycloaliphatic hydrocarbons such as hexane, cyclohexane, heptane, cycloheptane, octane and isomers thereof, nonane and isomers thereof, decane and isomers thereof, and mixtures thereof.

For production of particulate composite materials, it has additionally been found to be useful to conduct the reaction of compound A with compound B in the presence of at least one surface-active substance, preferably in an inert diluent.

Suitable surface-active substances are particularly anionic emulsifiers and nonionic emulsifiers.

Anionic emulsifiers generally have, as well as at least one hydrophobic group, for example at least one aliphatic group or araliphatic group having at least 6 carbon atoms, especially at least 10 carbon atoms, or at least one oligo- or poly(alkylsiloxane) group and at least one anionic group, for example 1 or 2 anionic groups selected, for example, from sulfonate groups and phosphonate groups, where the sulfonate groups and phosphonate groups may also be present as sulfate groups or phosphate groups. Preferred inorganic anionic emulsifiers have 1 or 2 sulfonate or sulfate groups.

The anionic emulsifiers include aliphatic, araliphatic and aromatic sulfonic acids have in general at least 6 carbon atoms and salts thereof, especially the ammonium and alkali metal salts thereof, sulfuric monoesters of ethoxylated alkanols and alkylphenols and salts thereof, especially the ammonium and alkali metal salts thereof, and alkyl, aralkyl and aryl phosphates including phosphoric monoesters of alkanols and alkylphenols and salts thereof, especially the ammonium and alkali metal salts thereof.

Preferred anionic emulsifiers are:
alkali metal and ammonium salts of dialkyl esters of sulfosuccinic acid (alkyl radical: C₈ to C₁₆),
alkali metal and ammonium salts of alkyl sulfates (alkyl radical: C₈ to C₁₈),
alkali metal and ammonium salts of alkyl sulfonates (alkyl radical: C₈ to C₁₈),
alkali metal and ammonium salts of alkylarylsulfonic acids (alkyl radical: C₈ to C₁₈),
compounds of the general formula

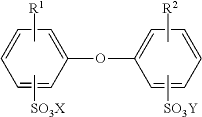

in which R¹ and R² are each hydrogen or C₄- to C₁₈-alkyl and are not both hydrogen, and X and Y may each be alkali metal ions and/or ammonium ions. R¹, R² are preferably each linear or branched alkyl radicals having 6 to 14 carbon atoms or hydrogen, and especially having 6, 12 and 16 carbon atoms, where R¹ and R² are not both hydrogen at the same time. X and Y are preferably sodium, potassium or ammonium ions, particular preference being given to sodium. Particularly advantageous compounds are those in which X and Y are sodium, R¹ is a branched alkyl radical having 12 carbon atoms and R² is hydrogen or one of the definitions given for R¹ other than hydrogen. Frequently, technical mixtures having a proportion of 50 to 90% by weight of the monoalkylated product are used, for example Dowfax®2A1 (trade mark of the Dow Chemical Company).

The anionic emulsifiers may also be used in their acidic form and in that case act as initiators.

Examples of suitable nonionic emulsifiers are typically ethoxylated alkanols having 8 to 36 carbon atoms in the alkyl radical, ethoxylated mono-, di- and trialkylphenols having typically 4 to 12 carbon atoms in the alkyl radicals, where the ethoxylated alkanols and alkylphenols typically have a degree of ethoxylation in the range from 2 to 100, especially 3 to 50. Examples of suitable nonionic surface-active compounds are also ethoxylated oligo- and poly(dialkylsiloxanes), especially ethoxylated oligo- and poly(dimethylsiloxanes), where these compounds have at least 2, for example 2 to 50, dialkylsiloxane units and a degree of ethoxylation in the range from 2 to 100, especially 3 to 50.

The polymerization of compounds A and B may be followed by purification steps and optionally drying steps.

The polymerization of compounds A and B may be followed by a calcination. This involves carbonizing the organic polymeric material formed in the polymerization of the monomer unit(s) B to the carbon phase.

The polymerization of compounds A and B may be followed by an oxidative removal of the organic polymer phase. This involves oxidizing the organic polymeric material formed in the polymerization of the organic constituents to obtain a nanoporous oxidic or nitridic material.

The composite material obtainable by the process according to the invention has at least one oxidic phase which comprises the metal, semimetal or the nonmetal other than C and N, and at least one organic polymer phase which results from the polymerization of the aryloxy groups with the formaldehyde. The dimensions of the phase domains in the composite material thus obtained are usually in the region of a few nanometers, but it is possible to obtain materials with domain sizes up to 100-200 nm. In addition, the phase domains of the oxidic phase and the phase domains of the organic phase generally have a co-continuous arrangement, i.e. both the organic phase and the inorganic or organometallic phase penetrate one another and essentially do not form any discontinuous regions. The distances between adjacent phase boundaries, or the distances between the domains of adjacent identical phases, are extremely small and are on average not more than 100 nm, frequently not more than 50 nm, particularly not more than 10 nm or not more than 5 nm and especially not more than 2 nm, but is possible to obtain materials with domain sizes up to 100-200 nm. There is no occurrence of microscopically visible separation into discontinuous domains of the particular phase.

The mean distance between the domains of adjacent identical phases can be determined by means of combined small-angle X-ray scattering (SAXS) via the scatter vector q (measurement in transmission at 20° C., monochromatized CuK_{α} radiation, 2D detector (image plate), slit collimation).

With regard to the terms “continuous phase domain”, “discontinuous phase domain” and “co-continuous phase domain”, reference is also made to W. J. Work et al. Definitions of Terms Related to Polymer Blends, Composites and Multiphase Polymeric Materials, (IUPAC Recommendations 2004), Pure Appl. Chem., 76 (2004), p. 1985-2007, especially p. 2003. According to this, a co-continuous arrangement of a two-component mixture is understood to mean a phase-separated arrangement of the two phases, in which within one domain of the particular phase a continuous path through either phase domain may be drawn to all phase boundaries without crossing any phase domain boundary.

The composite materials obtainable in accordance with the invention can be converted in a manner known per se to nanoporous inorganic materials, by oxidatively removing the organic constituents of the inventive nanocomposite material. This preserves the nanostructure of the inorganic phase present in the inventive nanocomposite material, and the result, depending on the compounds A selected, is an oxide of the (semi)metal or of the nonmetal, or a mixed form. The oxidation is effected typically by heating in an oxygenous atmosphere as described in the article by Spange et al. cited at the outset. In general, heating is effected with ingress of oxygen at a temperature in the range from 400 to 1500° C., especially in the range from 500 to 1000° C. The heating is effected typically in an oxygenous atmosphere, for example in air or other oxygen/nitrogen mixtures, the proportion of oxygen being variable over wide ranges and being, for example, in the range from 5 to 50% by volume.

The composite materials obtainable in accordance with the invention can also be converted to an electrically active nanocomposite material which, as well as an inorganic phase of a (semi)metal which may either be oxidic or (semi)metallic in nature, has a carbon phase C. Such materials are obtainable by calcining the composite material obtainable in accordance with the invention with substantial or complete exclusion of oxygen. In the carbonaceous nanocomposite material, the carbon phase C and the inorganic phase form essentially co-continuous phase domains, where the mean distance between two adjacent domains of identical phases is generally not more than 10 nm. In general, the calcination is performed at a temperature in the range from 400 to 2000° C., especially in the range from 500 to 1000° C. The calcination is then effected typically with substantial exclusion of oxygen. In other words, during the calcination, the partial oxygen pressure in the reaction zone in which the calcination is performed is low, and will preferably not exceed 20 mbar, especially 10 mbar. Preference is given to performing the calcination in an inert gas atmosphere, for example under nitrogen or argon. The inert gas atmosphere will preferably comprise less than 1% by volume, especially less than 0.1% by volume, of oxygen. In a likewise preferred embodiment of the invention, the calcination is performed under reducing conditions, for example in an atmosphere which comprises hydrogen (H₂), hydrocarbon gases such as methane, ethane or propane, or ammonia (NH₃), optionally as a mixture with an inert such as nitrogen or argon. To remove volatile constituents, the calcination can be performed in an inert gas stream or in a gas stream which comprises reducing gases such as hydrogen, hydrocarbon gases or ammonia.

The inventive obtainable composite materials and the porous, especially nanoporous, inorganic materials produced therefrom, and also the electroactive nanocomposite materials which, as well as an inorganic phase, which may be either oxidic or (semi)metallic, of a (semi)metal, have a carbon phase C, can be used successfully in many applications to solve known problems or to improve properties.

For example, the composite materials obtainable in accordance with the invention are suitable for production of porous carbon materials for the storage of gases, especially for H₂ storage, for example in analogy to the manner described in WO 2009/083082. Reference is hereby made completely to the disclosure in this regard in WO 2009/083082.

The composite materials obtainable in accordance with the invention, especially those which comprise silicon, are also suitable for production of elastomer or rubber blends, especially rubber blends for the production of pneumatic tires, for example in analogy to the manner described in US 2011-0240197. Reference is made completely to the disclosure in this regard in US 2011-0240197.

The composite materials obtainable in accordance with the invention are additionally suitable for production of porous oxidic materials which are used as what are called low-k dielectrics, i.e. as dielectrics with low dielectric constant (k<3.7), for example in analogy to the manner described in WO 2009/133082. Reference is hereby made completely to the disclosure in this regard in WO 2009/133082.

The composite materials obtainable in accordance with the invention, especially those which comprise silicon, are additionally suitable for production of electroactive materials suitable for lithium ion batteries, especially for anode materials, for example in analogy to the manner described in WO 2010/112580. Reference is hereby made completely to the disclosure in this regard in WO 2010/112580.

In addition, the inventive composite materials can be used in analogy to the manner described in WO 2011/000858 for production of separators for electrochemical cells, especially for lithium cells. Reference is hereby made completely to the disclosure in this regard in WO 2011/000858.

In addition, the inventive composite materials can be used in analogy to the manner described in WO 2011/039139 for production of membranes for separating processes. Reference is hereby made completely to the disclosure in this regard in WO 2011/039139.

The examples and figures which follow serve to illustrate the invention.

### I. ANALYSIS

The samples obtained in the copolymerization were analyzed by means of TEM: the TEM analyses were performed as HAADF-STEM with a Tecnai F20 transmission electron microscope (FEI, Eindhoven, the Netherlands) at a working voltage of 200 kV in the ultrathin layer technique (embedding of the sample into synthetic resin as a matrix). The results are shown in FIGS. 1a, 1b, 2a, 2b, 3 and 4 which follow. Arrows in the figures indicate particularly characteristic regions of the sample, which show that the domain distances are in the region of a few nm (<10 nm).

### II. FIGURES

FIG. 1a: HAADF-STEM analysis of the sample from example 1 with a magnification of 2×10⁵.

FIG. 1b: HAADF-STEM analysis of the sample from example 1 with a magnification of 10⁶.

FIG. 2a: HAADF-STEM analysis of the sample from example 2 with a magnification of 2×10⁴. Homogeneously black areas are attributable to the embedding material.

FIG. 2b: HAADF-STEM analysis of the sample from example 2 with a magnification of 10⁶.

FIG. 3: HAADF-STEM analysis of the sample from example 3 with a magnification of 10⁶.

FIG. 4: HAADF-STEM analysis of the sample from example 4 with a magnification of 10⁶.

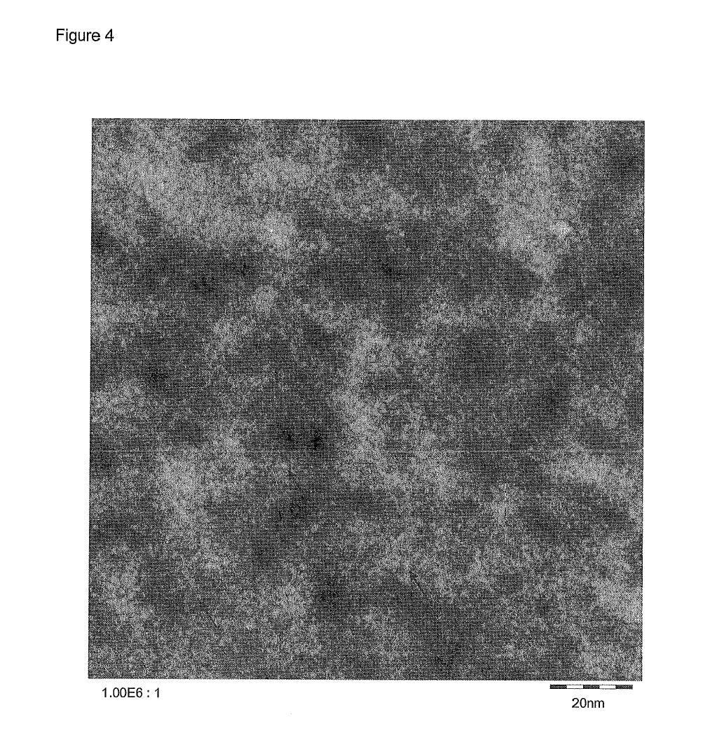

FIG. 5: HAADF-STEM analysis of the sample from example 9 with a magnification of 10⁶.

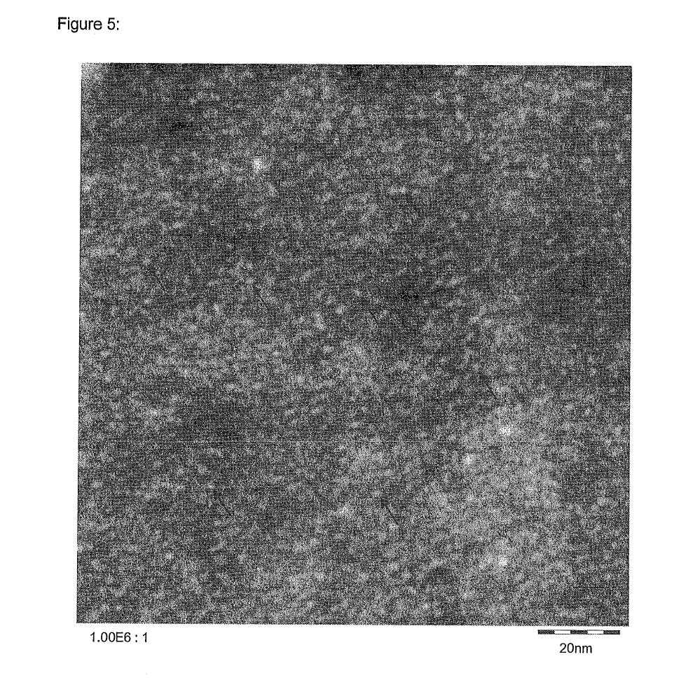

FIG. 6: HAADF-STEM analysis of the sample from example 20 with a magnification of 10⁶.

### III. COMPOUNDS A USED

Tetraphenyl silicate (compound of the formula I where M=Si, m=4, n=p=0, q=1, Ar=phenyl)

A 2 l four-neck flask equipped with glass stirrer and sleeve, condenser with bubble counter and scrubbing tower was initially charged with 498 g of phenol, which were melted at 70° C. 270 g of SiCl₄ were added dropwise such that the scrubbing tower could bind the amounts of HCl formed. When evolution of HCl declined, the internal temperature was increased gradually (approx. 6 h) to 250° C. This gave 550 g of a light-colored, clear oil which crystallized at room temperature.

¹H NMR (500 MHz, 16 scans, CD₂Cl₂): 7.25 ppm (2H, triplet), 7.05 ppm (1H, triplet), 7.03 ppm (2H, doublet)

Hexaphenoxycyclotrisiloxane (compound of the formula I where M=Si, m=2, n=1, p=0, q=3, or Ib where M=Si, m=4, n=0, p=0, k=1, Ar=phenyl)

a) A 1 I four-neck flask equipped with glass stirrer and sleeve, condenser with bubble counter and scrubbing tower was initially charged with 188 g of phenol, which were melted at 50° C. 170 g of SiCl₄ were added dropwise such that the scrubbing tower could bind the amounts of HCl formed. When evolution of HCl declined, the internal temperature was increased gradually (approx. 6 h) to 250° C. This gave 310 g of a light-colored, clear oil.

¹H NMR (500 MHz, 16 scans, CD₂Cl₂): 2 signal groups 7.4.-7.2 ppm (2×2H), 6.95-7.15 ppm (2×3H)

b) A 0.5 I four-neck flask equipped with glass stirrer and sleeve, condenser with bubble counter and scrubbing tower was initially charged with 57 g of the adduct from a) in 200 ml of toluene. 3.2 g of water in 50 ml of dry THF were added dropwise at 25° C. and the mixture was stirred for a further 1 h. The solution was filtered with suction with exclusion of water and concentrated on a rotary evaporator at 80° C./10 mbar. This gave 38 g of light-colored, clear oil which crystallized.

¹H NMR (500 MHz, 16 scans, CD₂Cl₂): 7.25 ppm (triplet, 3×2H); 7.04 ppm (triplet, 3×1H); 7.03 ppm (doublet, 3×2H)

Triphenyl metaborate (compound of the formula I where M=B, m=1, n=1, p=0, q=3 and Ar=phenyl or Ib where M=B, m=3, n=0, p=0, k=1 and Ar=phenyl) A 2 l four-neck flask equipped with glass stirrer, thermometer and condenser was initially charged with 156 g of boric acid and 400 ml of xylene. The mixture was heated to reflux. After 2 h, the condenser was removed and a water trap was attached. Within 3 h, a total of 41 ml of water was trapped at an internal temperature of 122-138° C. Subsequently, the reaction mixture was heated to reflux and a solution of 226 g of phenol in 300 ml of xylene was added thereto within 1 h. Thereafter, the mixture was stirred under reflux for a further 5 h and a further 22 ml of water in total were separated out. The reaction mixture obtained was concentrated to dryness at 100° C. and 5 mbar. This gave 230 g of title compound as a solid.

¹H NMR (500 MHz, 16 scans, CD₂Cl₂): 7.29 ppm (2H, triplet), 7.12 ppm (1H, triplet), 7.05 ppm (2H, doublet)

p-Tolyl diphenyl metaborate (mixture of compounds of the formula I where M=B, m=1, n=1, p=0, q=3 and Ar=phenyl and p-tolyl, or mixture of compounds of the formula Ib where M=B, m=3, n=0, p=0, k=1 and Ar=phenyl and 4-methylphenyl)

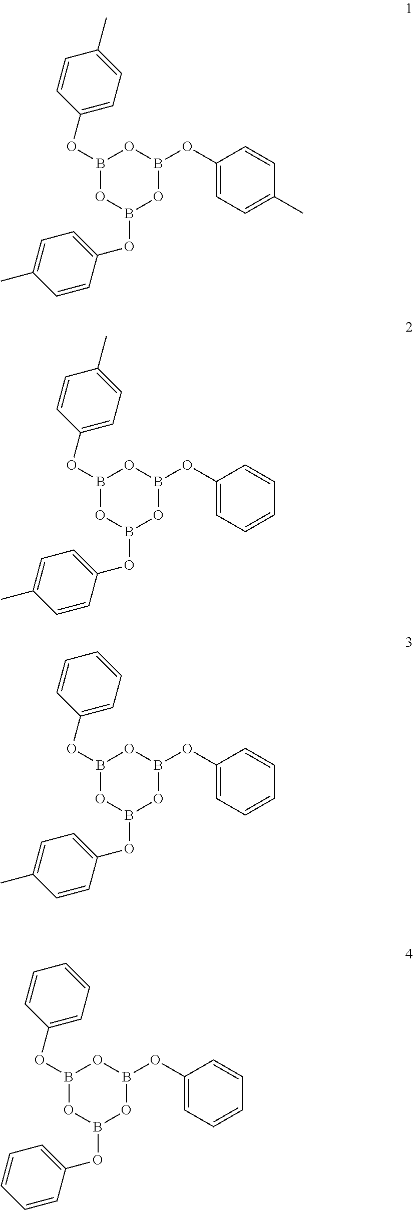

A 2 l four-neck flask equipped with glass stirrer, thermometer and condenser was initially charged with 185 g of boric acid and 500 ml of xylene. The mixture was heated to reflux. After 2 h, the condenser was removed and a water trap was attached. Within 3 h, a total of 52 ml of water was trapped at an internal temperature of 122-137° C. Subsequently, the reaction mixture was heated to reflux and a solution of 198 g of phenol and 108 g of p-cresol in 300 ml of xylene was added thereto within 1 h. Thereafter, the mixture was stirred under reflux for a further 5 h and a further 46 ml of water in total were trapped. The reaction mixture obtained was concentrated to dryness at 100° C. and 5 mbar. This gave 340 g of mixture of tri-p-tolyl metaborate (1), di-p-tolyl phenyl metaborate (2), p-tolyl-diphenyl metaborate (3) and triphenyl metaborate (4) in solid form.

¹H NMR (500 MHz, 16 scans, CD₂Cl₂):

7.4-6.6 ppm (14H, various superimposed aromatic signals)

2.31 ppm (3H, singlet)

Tetraphenyl titanate (compound of the formula I where M=Ti, m=4, n=p=0, q=1, Ar=phenyl)

The preparation was effected by the method described in DE 1816241.

Tetracresyl titanate (compound of the formula I where M=Ti, m=4, n=p=0, q=1, Ar=4-methylphenyl)—commercial product

Triphenyl phosphate (compound of the formula I where M=P, m=3, n=1, p=0, q=1, Ar=phenyl)—commercial product

Aluminum phenoxide: (compound of the formula I where M=Al, m=3, n=p=0, q=1, Ar=phenyl)

A 0.5 I four-neck flask equipped with stirrer, condenser with bubble counter and scrubbing tower was initially charged with 188 g of phenol which were melted at 50° C. 30 g of AlCl₃ were added in 3 portions at 50°-70° C., and the temperature was then increased to approx. 180° C. each time and maintained until the HCl evolution had ended. Subsequently, excess phenol was drawn off at bath temperature 180° C., and a water-jet vacuum was applied at the end. In this way, 95 g of the title compound were obtained as an oil which solidifies in crystalline form at approx. 130° C. The title compound is insoluble in dichloromethane, acetone, chloroform or toluene, and soluble in DMSO.

¹H NMR (500 MHz, 16 scans, DMSO-D₆): 9.36 ppm (1H, singlet), 7.16 ppm (2H, triplet), 6.76 ppm (1H, triplet), 6.75 ppm (2H, doublet), and also approx. 5% free phenol and water at 3.34 ppm and DMSO-D₅

Tetra(4-methylphenyl) silicate (compound of the formula I where M=Si, m=4, n=p=0, q=1, Ar=4-methylphenyl)

A 1 I four-neck flask equipped with glass stirrer, condenser with bubble counter and scrubbing tower was initially charged with 229 g of p-cresol which were melted at 50° C. 107 g of SiCl₄ were added dropwise thereto at such a rate that the scrubbing tower could bind the amounts of HCl formed. As HCl evolution declined, the internal temperature was increased gradually (over approx. 6 h) to 250° C. This gave 210 g of a light-colored, clear oil which crystallized at room temperature.

¹H NMR (500 MHz, 16 scans, CD₂Cl₂): 7.04 ppm (2H, doublet), 6.89 ppm (2H, doublet),

Diphenoxydimethylsilane (compound of the formula I where M=Si, m=2, n=0, p=2, q=1, Ar=phenyl, R=methyl)

A 1 I four-neck flask equipped with glass stirrer, condenser with bubble counter and scrubbing tower was initially charged with 344 g of phenol which were melted at 50° C. 227 g of (CH₃)₂SiCl₂ were added dropwise thereto at such a rate that the scrubbing tower could bind the amounts of HCl formed. As evolution of HCl declined, the internal temperature was increased gradually (over approx. 6 h) to 250° C. This gave 440 g of a light-colored, clear oil.

¹H NMR (500 MHz, 16 scans, CD₂Cl₂): 7.24 ppm (2×2H, triplet), 6.98 ppm (2×1H, triplet), 6.94 ppm (2×2H, doublet), 0.36 ppm (2×3H, singlet)

### IV. INVENTIVE EXAMPLES

### Example 1

### Polymerization of Tetraphenyl Silicate in Bulk

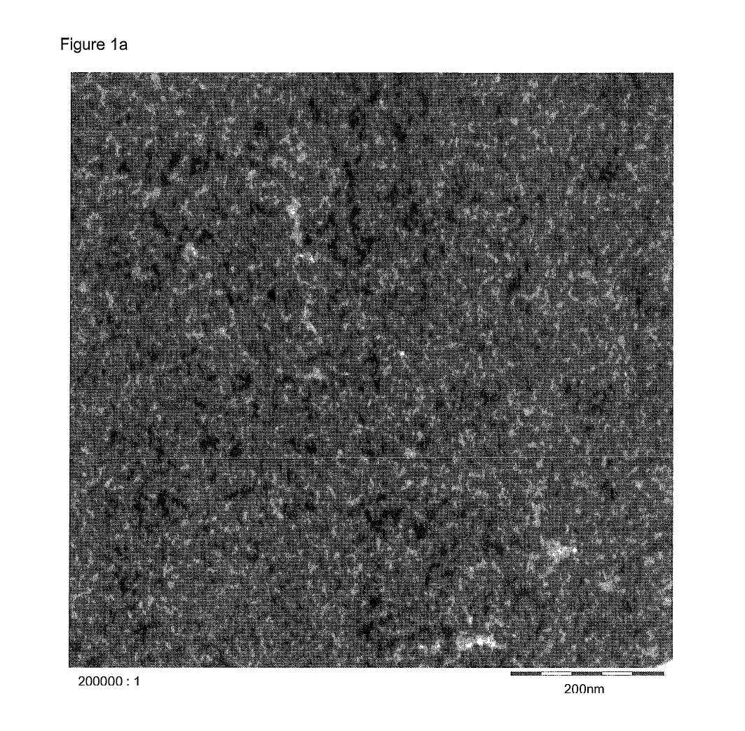

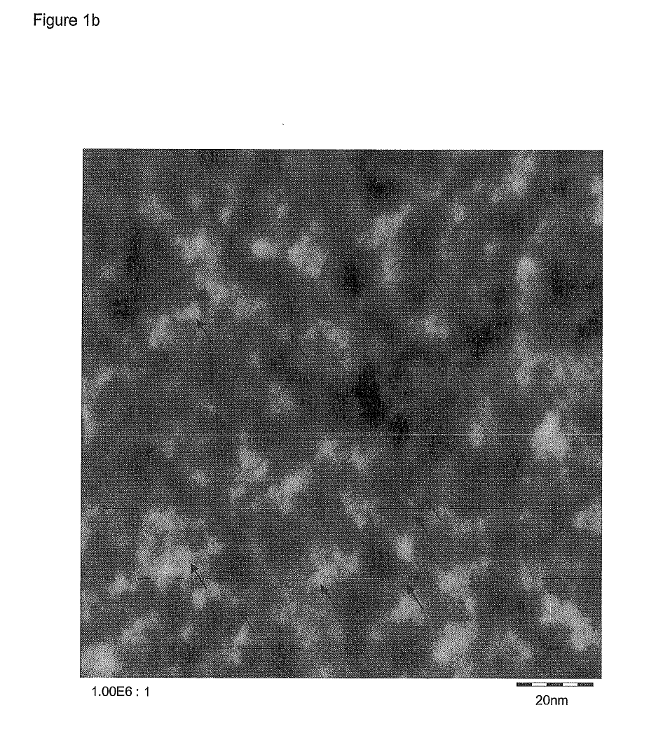

3 g of trioxane and 10 g of tetraphenyl silicate were melted at 65° C. in a 100 ml round-bottom flask on a rotary evaporator to obtain a homogeneous, clear solution. 100 mg of trifluoroacetic acid were added thereto and the mixture was homogenized. An amount of 5 g was transferred to a penicillin bottle, provided with a crimp cap and heated to 90-100° C. in a drying cabinet. After 15 h, 4.4 g of a clear, transparent resin were obtained. A sample of the resin obtained was analyzed by HAADF-STEM. The phase structure was shown in FIGS. 1a and 1b and demonstrates the presence of domain sizes in the region of a few nanometers (<10 nm).

### Example 2

### Precipitation Polymerization of Tetraphenyl Silicate in Solution

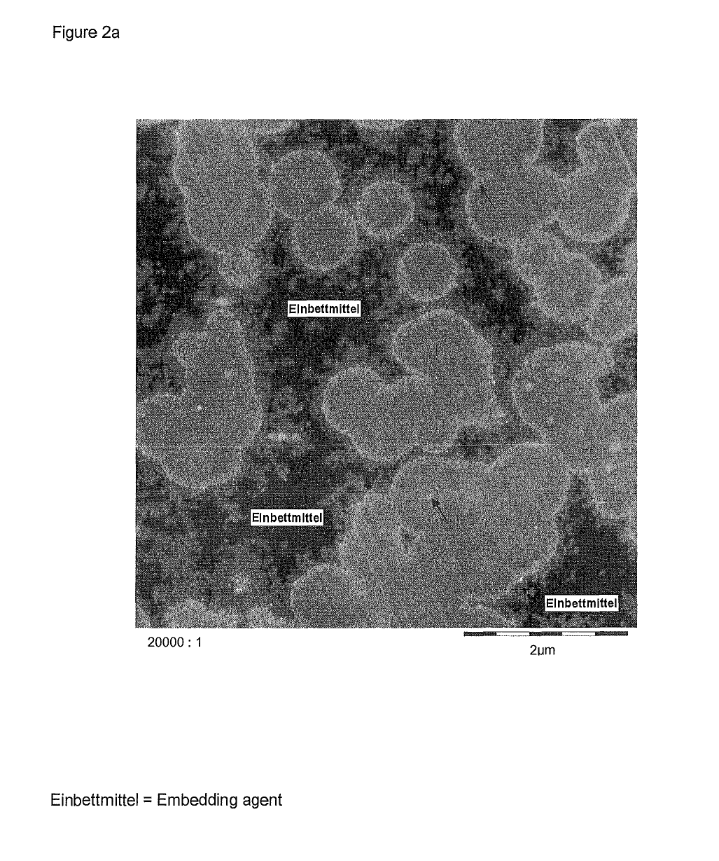

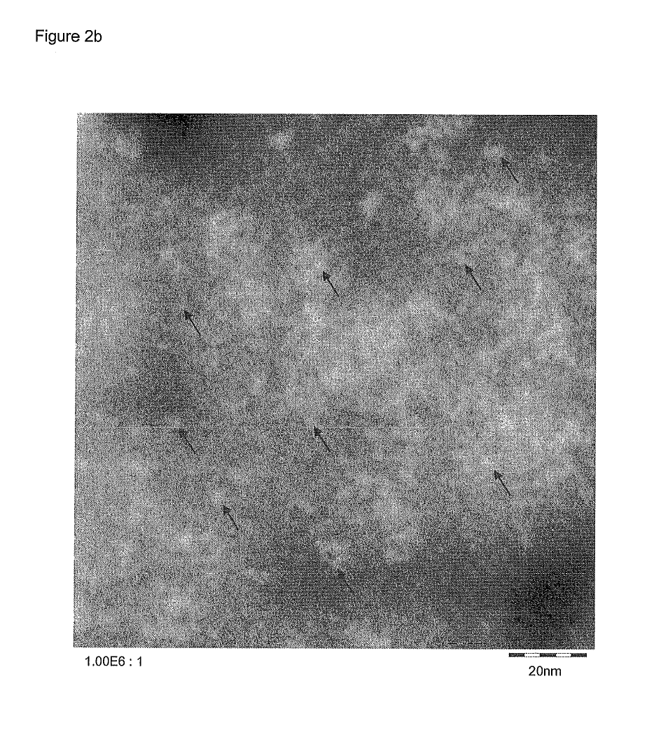

In a 250 ml four-neck flask, 20.0 g of tetraphenyl silicate were melted at 40-50° C. with 6.6 g of trioxane under nitrogen, and diluted with 80 g of xylene. 0.2 g of methanesulfonic acid was added thereto at 50° C. and the mixture was homogenized. Subsequently, the mixture was stirred at a stirrer speed of 500-600 rpm at 80° C. for 30 min, at 100° C. for 30 min and at 120° C. for 30 min. The mixture became pasty and a further 60 g of xylene was added and the mixture was boiled at reflux for a further 30 min. The mixture was cooled to room temperature, filtered through a D4 frit, washed with xylene and dried in a vacuum drying cabinet. This gave 22.5 g of a fine pink powder with a mean particle size of 14 μm, which consists of spherical primary particles of diameter approx. 1 μm (see FIG. 2a). The primary particles exhibited the domain structures typical of a twin polymerization, with dimensions in the range of 2-5 nm (see FIG. 2b).

### Example 3

### Polymerization of Triphenyl Phosphate in Bulk

33 g of trioxane and 109 g of triphenyl phosphate were melted at 50° C. in a round-bottom flask on a rotary evaporator to obtain a homogeneous, clear solution.

### Experiment a)

5 g of this solution were introduced into a 50 ml ampoule to which 51 mg of trifluoroacetic acid were added, and the mixture was homogenized. The ampoule was provided with a crimp cap and heated to 90-140° C. in a drying cabinet. After 5 d, 4.2 g of a dark brown resin were obtained.

### Experiment b)

5 g of this solution were introduced into a 50 ml ampoule to which 55 mg of lactic acid were added, and the mixture was homogenized. The ampoule was provided with a crimp cap and heated to 90-140° C. in a drying cabinet. After 5 d, 4.1 g of a dark green resin were obtained.

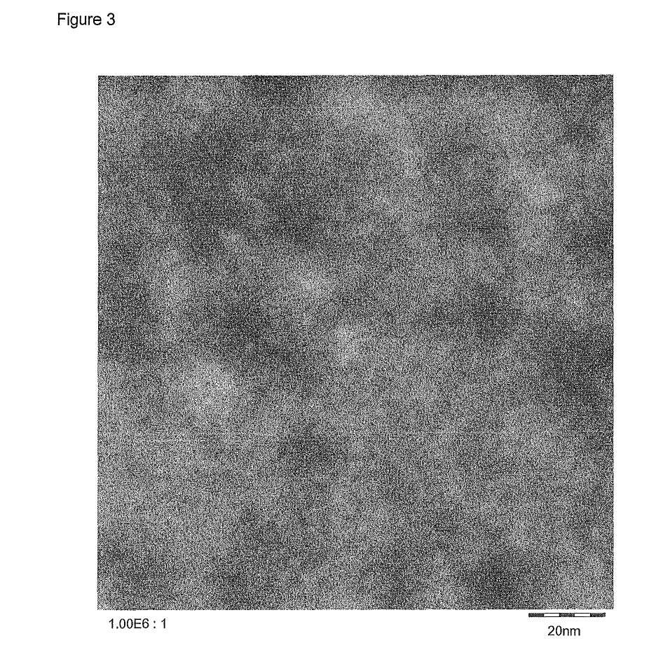

A sample of the resin obtained was analyzed by HAADF-STEM. The phase structure is shown in FIG. 3 and demonstrates the presence of domain sizes in the region of a few nanometers (<10 nm).

### Example 4

### Polymerization of Tetracresyl Titanate in Bulk

27.8 g of trioxane and 100 g of tetracresyl titanate were melted at 50° C. in a round-bottom flask on a rotary evaporator to obtain a homogeneous, clear solution. 5 g of this solution were introduced into a 50 ml ampoule and 61 mg of trifluoroacetic acid were added thereto, and the mixture was homogenized. The ampoule was provided with a crimp cap and heated to 120-140° C. in a drying cabinet. After 6 d, 4 g of a brittle, red-brown resin were obtained.

A sample of the resin obtained was analyzed by HAADF-STEM. The phase structure is shown in FIG. 3 and demonstrates the presence of domain sizes in the region of a few nanometers (<10 nm).

### Example 5

### Polymerization of Triphenyl Metaborate in Bulk

4 g of boric ester were melted at 90-100° C. in a 20 ml ampoule. 1.1 g of trioxane were added thereto. The sample was stored at 100° C. in a drying cabinet for 1d. This gave a polymer in an amount of 5 g.

### Example 6

### Precipitation Polymerization of Triphenyl Metaborate in Solution

In a 250 ml four-neck flask, 20.0 g of triphenyl borate were melted at 50-55° C. with 5.5 g of trioxane under nitrogen, and diluted with 80 g of xylene. 0.2 g of methanesulfonic acid was added thereto at 55° C. and the mixture was homogenized. Subsequently, the mixture was stirred at a stirrer speed of 600 rpm at 80° C. for 30 min, at 100° C. for 30 min and at 120° C. for 30 min. The mixture became cloudy and a sandy deposit formed at the flask wall. The mixture was cooled to room temperature, filtered through a D4 frit, washed with xylene and dried with a vacuum drying cabinet. This gave 20.5 g of a pink powder.

### Example 7

### Precipitation polymerization of p-tolyl diphenyl metaborate in solution

In a 500 ml HWS vessel with Ultra-Turrax stirrer and reflux condenser, 60.0 g of p-tolyl diphenyl metaborate (for substance mixture see above) were melted with 40 g of xylene and with 19.5 g of trioxane under nitrogen at 50-55° C., and the melt was diluted with 200 g of xylene. To this was added 0.8 g of methanesulfonic acid at 55° C., and the mixture was homogenized. Subsequently, the mixture was stirred at a stirrer speed of 8000 rpm at 80° C. for 30 min, at 100° C. for 30 min and at 120° C. for 30 min. The mixture became cloudy, and a sandy precipitate formed. The reaction mixture was cooled to room temperature and filtered with suction through a D4 frit, and the residue was washed with xylene and dried in a vacuum drying cabinet. This gave 58.5 g of a red powder.

The mean particle size (surface area average) of a powder determined by means of light scattering (Mastersizer 2000) was determined to be 27 μm.

Elemental analysis (thermally stable oxides can lead to low results):

| C₁₉H₁₇B₃O₆ | C | H | O | B | Total |
|---|---|---|---|---|---|
| Theory | 61.1 | 4.6 | 25.7 | 8.7 | 100.0 |
| Found | 54.9 | 5.4 | 26.0 | 6.8 | 93.1 |

### Examples 8-1 to 8-12

The compounds of the formula I specified in table 1 and trioxane were mixed in the amounts specified in table 1 and melted at 60 to 70° C. in a 20 ml penicillin bottle. Then 0.05 g of trifluoroacetic acid was added to the melt, and the penicillin bottle was closed with a metal-Teflon cap and heated to 110° C. for 48 h. The mixtures of examples 1 to 7 gave red to brown, clear transparent composite materials, and examples 8 to 12 red to brown opaque composite materials.

TABLE 1
(examples 8-1 to 8-12)

| Example | Monomer A [g] | Monomer B [g] | Monomer C [g] | Trioxane [g] |
|---|---|---|---|---|
| 1 | 5.00 | 1.00 | 0.00 | 1.78 |
| 2 | 4.00 | 2.00 | 0.00 | 1.92 |
| 3 | 3.00 | 3.00 | 0.00 | 1.86 |
| 4 | 2.00 | 4.00 | 0.00 | 1.90 |
| 5 | 1.00 | 5.00 | 0.00 | 1.94 |
| 6 | 5.00 | 0.00 | 0.00 | 1.45 |
| 7 | 0.00 | 0.00 | 0.00 | 1.65 |
| 8 | 5.00 | 1.00 | 2.00 | 2.32 |
| 9 | 4.00 | 2.00 | 2.00 | 2.36 |
| 10 | 3.00 | 3.00 | 2.00 | 2.40 |
| 11 | 2.00 | 4.00 | 2.00 | 2.44 |
| 12 | 1.00 | 5.00 | 2.00 | 2.48 |

Monomer A: tetra(4-methylphenyl) silicate
Monomer B: tetraphenyl silicate
Monomer C: diphenoxydimethylsilane

### Example 9

1.00 of tetraphenyl titanate and 0.32 g of trioxane were initially charged in a penicillin bottle and brought into solution by adding 1.3 g of toluene. The penicillin bottle was closed and heated to 90° C. After 1 h, the polymerization was complete. This gave a powder.

### Examples 10 to 16

### Production of Particulate Nanocomposite Materials

The particle size distribution of the powders produced in examples 10 to 16 was determined by means of Fraunhofer diffraction on a Malvern Master Sizer S, (module: MS7 cuvette, analysis model: polydisperse) at 23° C.

Elemental analysis: the Si was determined, after reacting the samples with concentrated sulfuric acid and then digestion with soda/borax, by optical emission spectroscopy (ICP-OES; from Varian, model: Varian Vista Pro). The carbon analysis was conducted by the conventional methods of elemental analysis (Dumas) (F. Ehrenberger “Quantitative organische Elementaranalyse” [Quantitative organic elemental analysis] ISBN 3-527-28056-1). Instrument: from Elementar, instrument type: elemental analyzer, model: Vario EL Cube or Vario Micro Cube.

### Example 10

A 2 l glass flask equipped with a stirrer, reflux condenser and metering devices was initially charged at room temperature and under a nitrogen atmosphere with tetraphenyl silicate (100 g), 1,3,5-trioxane (45 g) and xylene (isomer mixture, 850 g) which were heated to 80° C. while stirring (100 rpm) under atmospheric pressure. On attainment of the temperature, the stirrer speed was adjusted to 400 rpm and stirring was continued until a clear solution had formed (about 5 minutes). To this were added, within 10 min, a solution of 4-dodecylbenzenesulfonic acid (5.2 g) in xylene (isomer mixture, 40 g). Then the temperature was increased to 135° C. (bath temperature) and polymerization was effected under the given conditions for 3 hours. After cooling, a sample of the suspension was taken to determine the particle size distribution (weight average (D₅₀)=115 μm). The composite material was isolated by filtration and then dried (yield 142 g).

### Example 11

A 250 ml glass flask equipped with a magnetic stirrer and reflux condenser was initially charged at room temperature and under a nitrogen atmosphere with tetraphenyl silicate (18.4 g), 1,3,5-trioxane (8.3 g) and xylene (isomer mixture, 123 g), which were heated to 70° C. while stirring (325 rpm) under atmospheric pressure. On attainment of the temperature, 0.34 g of methanesulfonic acid was added. Then the temperature was increased to 135° C. and polymerization was effected under the given conditions for 3 hours. After cooling, the solid composite material was separated from the liquid reaction phase by filtration and then dried (yield 14.0 g). Elemental analysis: C 69.7%, Si 5.9%.

### Example 12

A 250 ml glass flask equipped with a magnetic stirrer and reflux condenser was initially charged at room temperature and under a nitrogen atmosphere with tetrakis(4-methyl-phenyl) silicate (10.8 g), 1,3,5-trioxane (4.2 g) and xylene (isomer mixture, 85.0 g), which were heated to 70° C. while stirring (325 rpm) under atmospheric pressure. On attainment of the temperature, 0.23 g of methanesulfonic acid was added. Then the temperature was increased to 135° C. and polymerization was effected under the given conditions for 3 hours. After cooling, the solid composite material was separated from the liquid reaction phase by filtration and then dried (yield 3.60 g). Elemental analysis: C 48.6%, Si 15.3%.

### Example 13

A 2 l glass flask equipped with a homogenizer (Polytron® PT 6100), baffles, reflux condenser and metering devices was initially charged at room temperature and under a nitrogen atmosphere with tetraphenyl silicate (48.3 g), 1,3,5-trioxane (21.7 g) and n-decane (400 g), which were heated to 80° C. while stirring (1000 rpm) at atmospheric pressure. On attainment of the temperature, the stirrer speed was adjusted to 7000 rpm and a solution of 4-dodecylbenzenesulfonic acid (7.0 g) in n-decane (40 g) was metered in within 10 minutes. Thereafter, the temperature was increased to 135° C. (bath temperature) and polymerization was effected under the given conditions for 3 hours. After cooling, a sample of the suspension was taken to determine the particle size distribution (weight average (D₅₀)=11 μm). The composite material was separated from the liquid reaction phase by filtration and then dried (yield 58.2 g).

### Example 14

A 2 l glass flask equipped with a homogenizer (Polytron® PT 6100), baffles, reflux condenser and metering devices was initially charged at room temperature and under a nitrogen atmosphere with tetraphenyl silicate (48.3 g), 1,3,5-trioxane (21.7 g) and n-decane (400 g), which were heated to 80° C. while stirring (1000 rpm) at atmospheric pressure. On attainment of the temperature, the stirrer speed was adjusted to 7000 rpm and sodium dodecylbenzenesulfonate (7.0 g) was added. Thereafter, a solution of methanesulfonic acid (1.1 g) in n-decane (40 g) was metered in within 10 minutes. The temperature was increased to 135° C. Under the given conditions, polymerization was effected for 3 hours. After cooling, a sample of the suspension was taken to determine the particle size distribution (weight average (D₅₀)=11 μm). The composite material was separated from the liquid phase by filtration and then dried (yield 57.5 g).

### Example 15

A 2 l glass flask equipped with a homogenizer (Polytron® PT 6100), baffles, reflux condenser and metering devices was initially charged at room temperature and under a nitrogen atmosphere with tetraphenyl silicate (48.3 g), 1,3,5-trioxane (21.7 g) and n-decane (400 g), which were heated to 80° C. while stirring (1000 rpm) at atmospheric pressure. On attainment of the temperature, the stirrer speed was adjusted to 7000 rpm. Sodium dodecylbenzenesulfonate (7.0 g) was added thereto, and a solution of tin tetrachloride (2.5 g) in n-decane (40 g) was metered in within 10 minutes. Thereafter, the temperature was increased to 135° C. and polymerization was effected under the given conditions for 3 hours. After cooling, a sample of the suspension was taken to determine the particle size distribution (weight average (D₅₀)=18 μm). The composite material was separated from the liquid reaction phase by filtration and then dried (yield 28.8 g).

### Example 16

A 2 l glass flask equipped with a homogenizer (Polytron® PT 6100), baffles, reflux condenser and metering devices was initially charged at room temperature and under a nitrogen atmosphere with tetraphenoxytitanium (50.7 g), 1,3,5-trioxane (21.7 g) and n-decane (400 g), which were heated to 80° C. while stirring (1000 rpm) at atmospheric pressure. On attainment of the temperature, the stirrer speed was adjusted to 7000 rpm and sodium dodecylbenzenesulfonate (7.0 g) was added. Thereafter, the temperature was increased to 135° C. and polymerization was effected under the given conditions for 3 hours. After cooling, a sample of the suspension was taken to determine the particle size distribution (weight-average (D₅₀)=14 μm). The composite material was separated from the liquid reaction phase by filtration and then dried (yield 50.7 g).

### Use Examples

### Example 17

### Production of a B₂O₃/C Hybrid Material

8.9 g of the powder from example 7 were calcined in a tube furnace under an argon stream, and the following temperature/time profile was selected:

Heating to 800° C. at 3-4° C./min

Delay time of 120 min at 800° C.

Cooling to room temperature overnight.

This gave 4.9 g of a caked black powder which was comminuted readily to give the powder.

### Elemental Analysis:

| | C | H | O | B | Total |
|---|---|---|---|---|---|
| Found | 59.1 | 1.1 | 27.5 | 11.1 | 98.8 |

### Example 18

### Production of a High-Porosity Carbon

4 g of the powder from example 17 were stirred with 70 ml of water at 70° C. for 2 h. The mixture was then left to cool to 23° C. and filtered through a 4D glass frit. The residue was washed with a little water and dried at 60° C. in a vacuum drying cabinet. In this way, 2.6 g of a fine black powder were obtained, which consisted essentially of elemental carbon.

### Elemental Analysis:

| | C | H | O | B | Total |
|---|---|---|---|---|---|
| Found | 92.3 | 1.3 | 7.3 | 0.4 | 101.3 |

In a BET experiment, the surface properties of the carbon powder were determined:

Surface area (Langmuir evaluation): 715 m²/g

Surface area (multipoint evaluation): 517 m²/g

Total pore volume: 0.442 ml/g

Mean pore radius: 16.2 Å

### Example 19

### Recovery of Boric Acid

The water phase (filtrate) from example 18 was concentrated on a rotary evaporator up to 100° C./15 mbar. In this way, 2.2 g of a white powder were obtained, which was found to be boric acid B(OH)₃ by elemental analysis.

### Elemental Analysis:

| B(OH)₃ | C | H | O | B | Total |
|---|---|---|---|---|---|
| Theory | 0 | 4.9 | 77.8 | 17.5 | 100.0 |
| Found | <0.5 | 4.8 | 78 | 17.4 | 100.7 |

### Example 20

### Production of a Nanoporous Titanium Dioxide

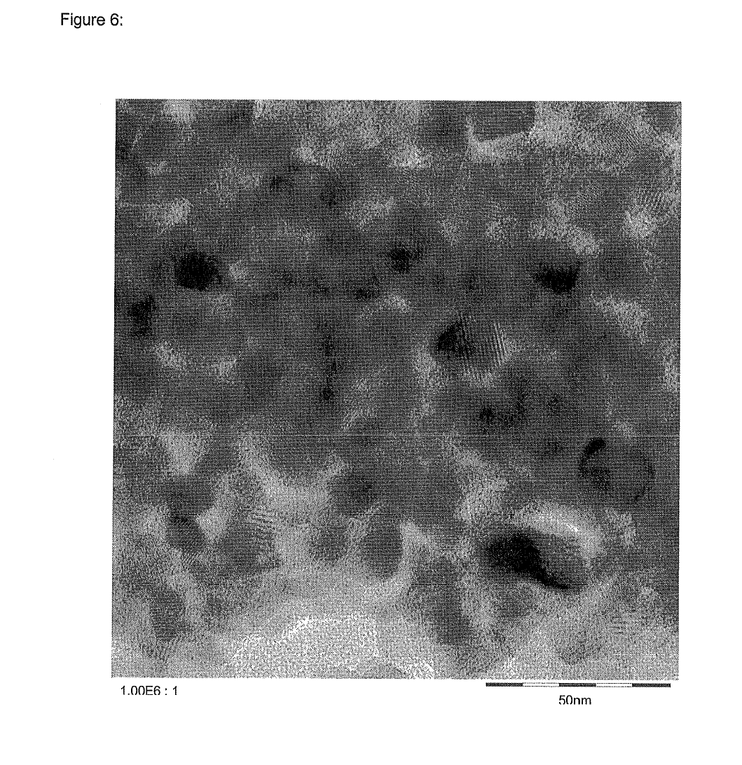

In a tube furnace, the powder from example 9 was heated to 500° C. in an air stream and held at this temperature for 4 h. In this way, a fine white powder was obtained, which was identified as titanium dioxide on the basis of elemental analysis. An X-ray powder diffractogram showed that it was titanium dioxide in the anatase polymorph. A TEM analysis is shown in FIG. 6.

1-20. (canceled)

21. A process for producing a composite material composed of
a) at least one oxidic phase; and
b) an organic polymer phase;
by copolymerizing
at least one compound A selected from aryloxy metalates, aryloxy semimetalates and aryloxy esters of nonmetals which form oxo acids and are different than carbon and nitrogen with
at least one compound B selected from formaldehyde and formaldehyde equivalents, in a reaction medium which is essentially anhydrous, wherein the compound B is used in such an amount that the molar ratio of formaldehyde to the aryloxy groups in compound A is at least 0.9:1.

22. The process according to claim 21, wherein metal, semimetal or nonmetal of the compounds A is selected from the elements other than carbon and nitrogen in groups IA, IIA, IIIA, IVA, VA, VIA, IVB, VB, VIIB and VIIB of the Periodic Table.

23. The process according to claim 21, wherein the metal, semimetal or nonmetal of the compounds A is selected from Li, Na, K, Mg, Ca, Sr, Ba, B, Al, Ga, In, Si, Ge, Sn, Pb, P, As, Sb, Bi, S, Ti, Zr, V, Cr, Mn and W.

24. The process according to claim 23, wherein the metal, semimetal or nonmetal of the compounds A is selected from B, Si, Sn, Ti and P.

25. The process according to claim 21, wherein compound A is selected from aryloxy semimetalates in which the semimetal comprises at least 90 mol %, based on the total amount of semimetal atoms, of silicon.

26. The process according to claim 21, wherein the compound B is used in such an amount that the molar ratio of formaldehyde in compound B to the aryloxy groups in compound A is in the range from 1:1 to 10:1.

27. The process according to claim 26, wherein the molar ratio of formaldehyde in compound B to the aryloxy groups in compound A is in the range from 1.05:1 to 2:1.

28. The process according to claim 21, wherein the compound A is described by the general empirical formula I:
[(ArO)ₘMOₙRₚ]_{q} (I)
in which
M is a metal, semimetal or a nonmetal which forms oxo acids and is different than carbon and nitrogen;
m is 1, 2, 3, 4, 5 or 6,
n is 0, 1 or 2,
p is 0, 1 or 2,
q is an integer,
m+2n+p is 1, 2, 3, 4, 5 or 6 and corresponds to the valency of M,
Ar is phenyl or naphthyl, where the phenyl ring or the naphthyl ring is unsubstituted or may have one or more substituents selected from alkyl, cycloalkyl, alkoxy, cycloalkoxy and NR^{a}R^{b} in which R^{a} and R^{b} are each independently hydrogen, alkyl or cycloalkyl;
R is alkyl, alkenyl, cycloalkyl or aryl, where aryl is unsubstituted or may have one or more substituents selected from alkyl, cycloalkyl, alkoxy, cycloalkoxy and NR^{a}R^{b} in which R^{a} and R^{b} are each as defined above.

29. The process according to claim 28, wherein q is 1, 2, 3, 4, 5, or 6.

30. The process according to claim 28, wherein M is selected from B, Si, Sn, Ti and P, m is 1, 2, 3 or 4, n is 0 or 1 and p is 0.

31. The process according to claim 28, wherein the compound A comprises at least two different compounds A1 and A2, where compound A1 is selected from compounds of the empirical formula I in which M is selected from B, Si, Sn, Ti and P, m is 1, 2, 3 or 4, n is 0 or 1 and p is 0, and the compound A2 is selected from compounds of the empirical formula I in which M is selected from Si and Sn, m is 2, n is 0 and p is 2.

32. The process according to claim 26, in which the compound A is selected from tetraphenoxysilane, hexaphenoxycyclotrisiloxane, octaphenoxycyclotetrasiloxane, tetra(4-methylphenoxy)silane, methyl(triphenoxy)silane, dimethyl(diphenoxy)silane, trimethyl(phenoxy)silane, phenyl(triphenoxy)silane, diphenyl(diphenoxy)silane, triphenyl borate, triphenyl metaborate, triphenyl orthophosphate, tetraphenyl titanate, tetracresyl titanate and tetraphenyl stannate.

33. The process according to claim 21, wherein compound B is selected from paraformaldehyde, trioxane and gaseous formaldehyde.

34. The process according to claim 21, wherein the polymerization is performed in the presence of an acid.

35. The process according to claim 34, wherein the acid is used in an amount of 0.1 to 10% by weight, based on compound A.

36. The process according to claim 21, wherein the polymerization is performed in one stage.

37. The process according to claim 21, wherein the polymerization is performed in an inert solvent.

38. The process according to claim 21, wherein the polymerization is performed in bulk.

39. A method for producing gas storage materials comprising utilizing a composite material obtained by the process according to claim 21.

40. A method for producing a rubber blend comprising utilizing a composite material obtained by the process according to claim 21.

41. A method for producing a low-K dielectric comprising utilizing a composite material obtained by the process according to claim 21.

42. A method for producing an electrode material for lithium ion batteries comprising utilizing a composite material obtained by the process according to claim 21.
